(19) United States
(12) Patent Application Publication
(10) Pub. No.: US 2022/0221863 A1
(43) Pub. Date: Jul. 14, 2022

(54) SYSTEMS AND METHODS FOR ALIGNMENT OF OBJECTS

(71) Applicant: SIGNIFY HOLDING B.V., EINDHOVEN (NL)

(72) Inventors: Wei Pien LEE, EINDHOVEN (NL); Maurice Herman Johan DRAAIJER, EINDHOVEN (NL); Harry BROERS, EINDHOVEN (NL); Jan EKKEL, EINDHOVEN (NL)

(21) Appl. No.: 17/609,870

(22) PCT Filed: May 18, 2020
(86) PCT No.: PCT/EP2020/063836

§ 371 Date: Nov. 9, 2021

(30) Foreign Application Priority Data
May 27, 2019 (EP) 19176702.9

(51) Int. Cl. G05D 1/00; G05D 1/02; H04N 7/18; B64C 39/02

(52) U.S. Cl. CPC G05D 1/0094; G05D 1/0202; B64C 2201/146; B64C 39/024; B64C 2201/123; H04N 7/185

(57) ABSTRACT

A system and method for positioning a payload over an object including a vehicle, the payload, the payload having a first surface, the first surface having a first engagement interface, the object, the object having a second engagement interface arranged to engage with the first engagement interface when the first engagement interface is aligned with the second engagement interface, a first electromagnetic radiation source arranged to generate a first electromagnetic radiation, the first electromagnetic radiation source positioned on the payload or connected to the vehicle, such that the first electromagnetic radiation is arranged to create a first electromagnetic radiation pattern on the object when the payload and the object are aligned.

### FIELD OF THE DISCLOSURE

The present disclosure is directed generally to lifting mechanisms, specifically to lifting mechanisms arranged to engage with an Unmanned Aerial Vehicle (UAV), even more specifically, to methods and systems for aligning a UAV and an object.

### BACKGROUND

Luminaires for street lamps and other electromagnetic radiation fixtures are typically mounted atop a pole or post making it difficult to install, replace, or maintain luminaires after the pole or post is mounted upright.

### SUMMARY OF THE DISCLOSURE

The present disclosure is related to systems and methods for lifting, installation, removal, and/or servicing of a luminaire or lamp, specifically systems and methods for allowing for remote and/or automated alignment of a UAV and an object.

In an aspect there is provided a system for positioning a payload above an object. The system may include a vehicle, for example, an unmanned aerial vehicle (UAV) having a body, a payload, the payload having a first surface, the first surface having a first engagement interface, an object, the object having a second engagement interface arranged to engage with the first engagement interface when the first engagement interface is aligned with the second engagement interface, the second engagement interface, a first electromagnetic radiation source arranged to generate a first electromagnetic radiation, the first electromagnetic radiation source positioned on the payload or connected to the UAV, such that the first electromagnetic radiation is arranged to create a first electromagnetic radiation pattern on the object when the payload and the object are aligned.

In an aspect, the UAV further comprises a camera arranged to capture a first image of the first electromagnetic radiation pattern on the object, the camera operatively engaged with the first electromagnetic radiation source.

In an aspect, the first electromagnetic radiation pattern is arranged to project onto an alignment window of the object when the payload is aligned with the object.

In an aspect, a second electromagnetic radiation source is provided, the second electromagnetic radiation source arranged to generate a second electromagnetic radiation, the second electromagnetic radiation source positioned on the payload or connected to the UAV, such that the second electromagnetic radiation is arranged to create a second electromagnetic radiation pattern on the object or on the first engagement interface of the UAV.

In an aspect, the first electromagnetic radiation pattern comprises a first horizontal component arranged substantially parallel to a first axis and a first vertical component arranged substantially parallel to a second axis orthogonal to the first axis, wherein the first vertical component is arranged to bisect the first horizontal component at a first intersection point.

In an aspect, the first horizontal component comprises a first right component arranged in a first direction along the first axis with respect to the first intersection point, the first right component having a first right component length, and a first left component arranged in a second direction along the first axis with respect to the intersection point, where the second direction is opposite the first direction, the first left component having a first left component length, wherein, the payload and object are aligned along the first axis when the first right component length and the first left component length are substantially equal.

In an aspect, the second electromagnetic radiation pattern includes a second horizontal component and a second vertical component wherein the second vertical component is arranged to bisect the second horizontal component at a second intersection point and wherein the payload and the object are aligned along the second axis when the first intersection point and the second intersection point overlap.

In an aspect, the second electromagnetic radiation pattern further comprises a second left component arranged in the first direction along the first axis with respect to the second intersection point, the second left component having a second left component length, and a second right component arranged in the second direction along the first axis with respect to the second intersection point, the second right component having a second right component length, wherein the payload and the object are aligned along the first axis when the ratio of the first left component to the first right component is substantially equal to the ratio of the second left component and the second right component.

In an aspect, the first electromagnetic radiation pattern comprises a first diagonal component and a second diagonal component, wherein the first diagonal component is arranged to bisect the second diagonal component at a third intersection point.

In an aspect, the second electromagnetic radiation pattern comprises a third diagonal component and a fourth diagonal component, wherein the third diagonal component is arranged to bisect the fourth diagonal component at a fourth intersection point and wherein the payload and the object are aligned along a second axis when the third intersection point and the fourth intersection point overlap.

In an aspect, the first electromagnetic radiation pattern is a first dot and the second electromagnetic radiation pattern is a second dot and the payload and the object are aligned along the second axis when the first dot overlaps the second dot.

In an aspect, the first electromagnetic radiation pattern comprises a first top edge created by a portion of first electromagnetic radiation contacting the first engagement interface and the second electromagnetic radiation pattern comprises a second top edge created by the second electromagnetic radiation contacting the first engagement interface wherein the payload and the object are aligned along the second axis when the first top edge overlaps the second top edge.

In an aspect, a method of aligning a payload and an object is provided, the method comprising: generating, via a first electromagnetic radiation source connected to a vehicle, for example, an unmanned aerial vehicle (UAV), or the payload, a first electromagnetic radiation, the first electromagnetic radiation arranged to project a first electromagnetic radiation pattern on an object while the UAV is in a first position with respect to the object; capturing, via a camera connected to the UAV, a first image, the first image including the first electromagnetic radiation pattern projected on the object while the UAV is in the first position; directing the UAV to move along a first axis or a second axis, where the second axis is orthogonal to the first axis, to a second position based at least in part on the first image, wherein the second position is aligned with the object along the first axis and/or the second axis.

In an aspect, the method further comprises: generating, via a second electromagnetic radiation source connected to the UAV or the payload, a second electromagnetic radiation, the second electromagnetic radiation arranged to project a second electromagnetic radiation pattern on the object while the UAV is in the first position with respect to the object, wherein the first electromagnetic radiation pattern and the second electromagnetic radiation pattern are arranged to project onto an alignment window of the object when the payload is aligned with the object along the first axis and/or the second axis.

In an aspect, the method further comprises: generating, via a second electromagnetic radiation source connected to the UAV or the payload, a second electromagnetic radiation, the second electromagnetic radiation arranged to project a second electromagnetic radiation pattern on the object, wherein the first electromagnetic radiation pattern is arranged to overlap the second electromagnetic radiation pattern when the payload and the object are aligned along the first axis and/or the second axis.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a perspective view of a positioning system according to the present disclosure.

FIG. 2A is a front view of a positioning system according to the present disclosure.

FIG. 2B is a side view of a positioning system according to the present disclosure.

FIG. 2C is a front view of a positioning system according to the present disclosure.

FIG. 2D is a side view of a positioning system according to the present disclosure.

FIG. 3A is a front view of a positioning system according to the present disclosure.

FIG. 3B is a side view of a positioning system according to the present disclosure.

FIG. 3C is a front view of a positioning system according to the present disclosure.

FIG. 3D is a side view of a positioning system according to the present disclosure.

FIG. 4A is a front view of a positioning system according to the present disclosure.

FIG. 4B is a side view of a positioning system according to the present disclosure.

FIG. 4C is a front view of a positioning system according to the present disclosure.

FIG. 4D is a side view of a positioning system according to the present disclosure.

FIG. 5A is a front view of a positioning system according to the present disclosure.

FIG. 5B is a side view of a positioning system according to the present disclosure.

FIG. 5C is a front view of a positioning system according to the present disclosure.

FIG. 5D is a side view of a positioning system according to the present disclosure.

FIG. 6A is a front view of a positioning system according to the present disclosure.

FIG. 6B is a side view of a positioning system according to the present disclosure.

FIG. 6C is a front view of a positioning system according to the present disclosure.

FIG. 6D is a side view of a positioning system according to the present disclosure.

FIG. 7A is a front view of a positioning system according to the present disclosure.

FIG. 7B is a side view of a positioning system according to the present disclosure.

FIG. 7C is a front view of a positioning system according to the present disclosure.

FIG. 7D is a side view of a positioning system according to the present disclosure.

FIG. 8 is a perspective view of a positioning system according to the present disclosure.

FIG. 9A is a front view of a positioning system according to the present disclosure.

FIG. 9B is a side view of a positioning system according to the present disclosure.

FIG. 9C is a front view of a positioning system according to the present disclosure.

FIG. 9D is a side view of a positioning system according to the present disclosure.

FIG. 10A is an enlarged side view of the positioning system illustrated in FIG. 9B according to the present disclosure.

FIG. 10B is an enlarged side view of the positioning system illustrated in FIG. 9D according to the present disclosure.

FIG. 11A is a front view of a positioning system according to the present disclosure.

FIG. 11B is top plan view of object 114 according to the present disclosure.

FIG. 11C is a side view of a positioning system according to the present disclosure.

FIG. 11D is a side view of a positioning system according to the present disclosure.

FIG. 12A is a front view of a positioning system according to the present disclosure.

FIG. 12B is a side view of a positioning system according to the present disclosure.

FIG. 12C is a front view of a positioning system according to the present disclosure.

FIG. 12D is a side view of a positioning system according to the present disclosure.

FIG. 13 is a flow chart illustrating the steps of a method according to the present disclosure.

FIG. 14 is a flow chart illustrating the steps of a method according to the present disclosure.

### DETAILED DESCRIPTION OF EMBODIMENTS

The present disclosure is related to systems and methods for lifting, installation, removal, and/or servicing of a luminaire or lamp . . . .

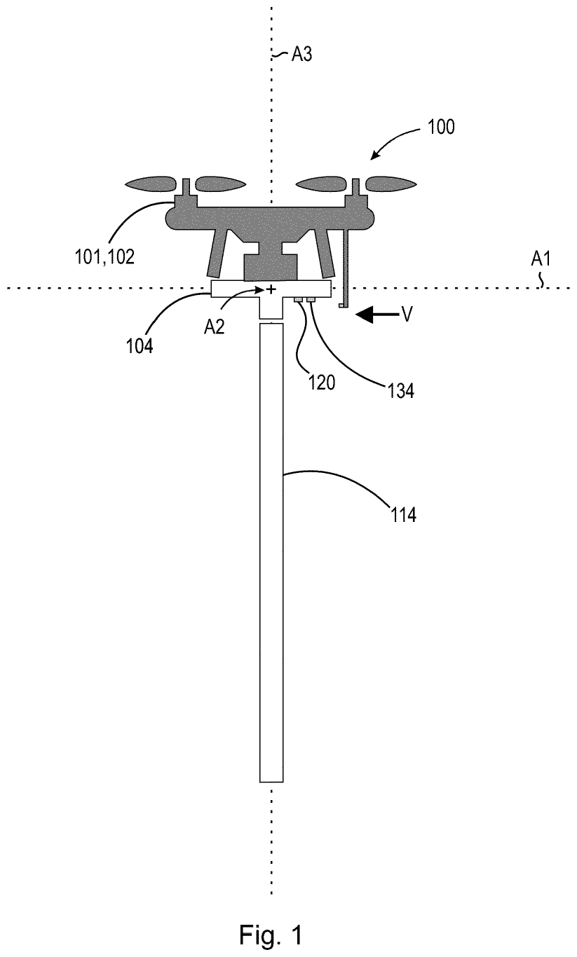

The following description should be read in view of FIGS. 1-12D. FIG. 1 illustrates a perspective view of positioning system 100. Positioning system 100 broadly includes a vehicle 101, for example, an unmanned aerial vehicle (UAV) 102 arranged to engage with, lift, and transport a payload 104. It should be appreciated, although the present disclosure illustrates and describes system 100 from the perspective of a UAV, i.e., UAV 102, vehicle may be a manned aerial vehicle, a manned or unmanned terrestrial vehicle, or any other vehicle capable of motorized and/or remote controlled motion to, for example, lift the weight of payload 104. UAV 102 is a device capable of sustained, unmanned flight. UAV 102 is intended to be a motorized, remote controlled, flying vehicle, for example, a drone, having enough lift force orthogonal to the surface of the ground in which is installed, to lift the combined weight of UAV 102 and payload 104. It should be appreciated that UAV 110 may include a first controller C having a first processor and first memory arranged to execute and store, respectively, a first set of non-transitory computer readable instructions arranged to perform the steps of the method outlined below. Additionally, first controller may be electrically connected to a first antenna arranged to receive wired or wireless communications from a remote device R. As will be discussed below, it should be appreciated that the first processor and first memory can be arranged to send and receive wireless data, for example, data related to first image 112 (not shown) such that a user or suitable image recognition module may further analyze the image data and drive UAV 102 to a more suitable position, i.e., a position that is aligned with the axes discussed below. It should be appreciated that the term image recognition module may refer to a set of non-transitory computer readable instructions, executable on a processor which can extract data from an image, e.g., feature point data or other known image recognition applications such that the distinguishing electromagnetic radiation patterns below may be discerned and automatically compensated for if it is determined that payload 104 is not aligned with object 114 as will be discussed below.

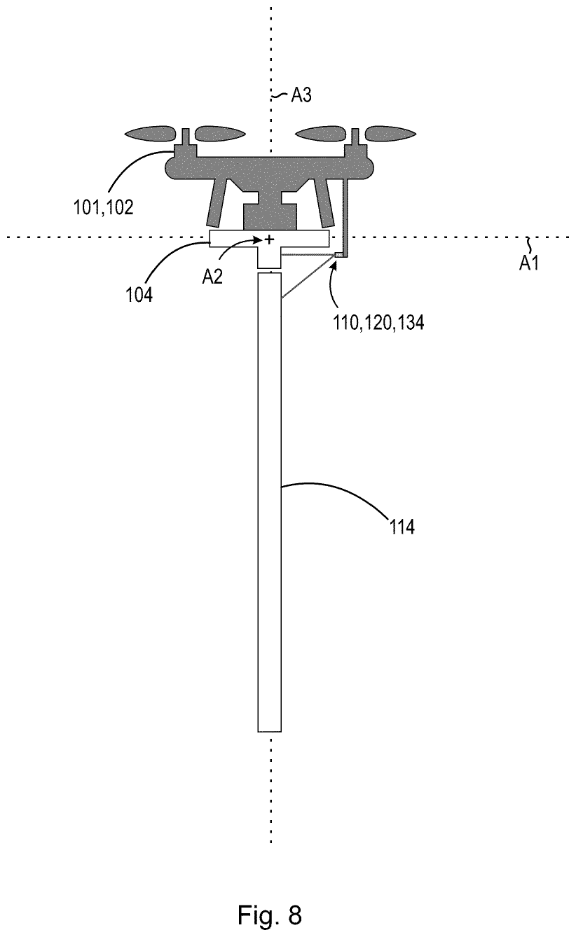

Payload 104 includes a first surface 106 having a first engagement interface 108 projecting therefrom in a direction orthogonal to first surface 106. Payload 104 is intended to be a lamp or luminaire arranged to engage, via the at least the first engagement interface 108 with an object, i.e., object 114 discussed below. Additionally, positioning system 100 may further include a camera 110 fixedly secured to either UAV 102 (as shown in FIGS. 1 and 8) or payload 104 (not shown). Camera 110 is arranged to capture a first image, i.e., first image 112 of object 114 and/or payload 104 from viewing angle V, as will be discussed below. It should be appreciated that camera 110 may capture a plurality of images in real-time, i.e., a video. First image 112 or a plurality of images in the form of a real-time video may be sent via the first antenna of the first controller of the UAV to the remote device R such that a user may use the visual indicators discussed below to align and/or position UAV 102 and payload 104 with respect to object 114 along a first axis A1 and/or a second axis A2, where the first axis A1 and the second axis A2 are arranged parallel to the surface of the ground within which object 114 is secured within or on and second axis A2 is orthogonal to the first axis A1.

Object 114 is intended to be a post, lamp post, or pole arranged to receive and fixedly secure to payload 104. Object 114 includes a second engagement interface 116 arranged at a first end of object 114 along a third axis A3 arranged orthogonal to the first axis A1 and the second axis A2, the second engagement interface 116 arranged to engage with first engagement interface 108 of payload 104. Second engagement interface may include a plurality of male or female oriented helical threads arranged to receive complementary plurality of male or female oriented helical threads of first engagement interface 108. Alternatively, first engagement interface 108 and second engagement interface 116 can include a pair of complementary magnets such that when first engagement interface 108 and second engagement interface 116 can magnetically couple when payload 104 and object 114 are aligned along the first axis A1 and/or the second axis A2 as will be discussed below. It should be appreciated that, in the alternative to complementary helical threads or complementary magnets, first engagement interface 108 and second engagement interface 116 can be arranged to engage via other mechanical connections, e.g., a slip-on arrangement where first engagement interface 108 is a substantially cylindrical projection arranged to encompass and slide over and around second engagement interface 116; a mechanical lock configuration where first engagement interface 108 is arranged to mechanically lock, in a translational or twisting motion around or with respect to third axis A3; or any other mechanical connection capable of removable securing payload 104 and object 114.

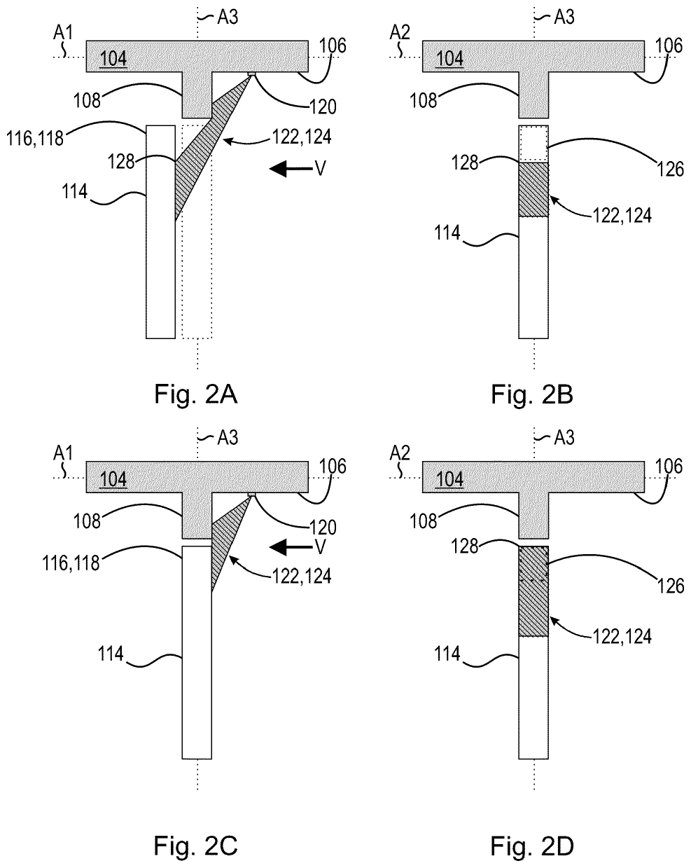

As illustrated in at least FIGS. 2A and 2C, second engagement interface 116 includes a vertical component having first outer circumferential surface 118. First outer circumferential surface 118 is arrange to receive a projected electromagnetic radiation, e.g., first electromagnetic radiation 122 and second electromagnetic radiation 136 discussed below, revealing an image or pattern which can be captured within first image 112 taken by camera 110. It should be appreciated that the electromagnetic radiation and electromagnetic radiation patterns discussed throughout this disclosure can be within and out of the visible spectrum of light such that the electromagnetic radiation patterns described herein may be observed or detected by a camera, e.g., camera 110 in situations where there may be visual noise, i.e., situations where it may be difficult to see an electromagnetic radiation pattern in the visible spectrum due to intense sunlight or other visual noise.

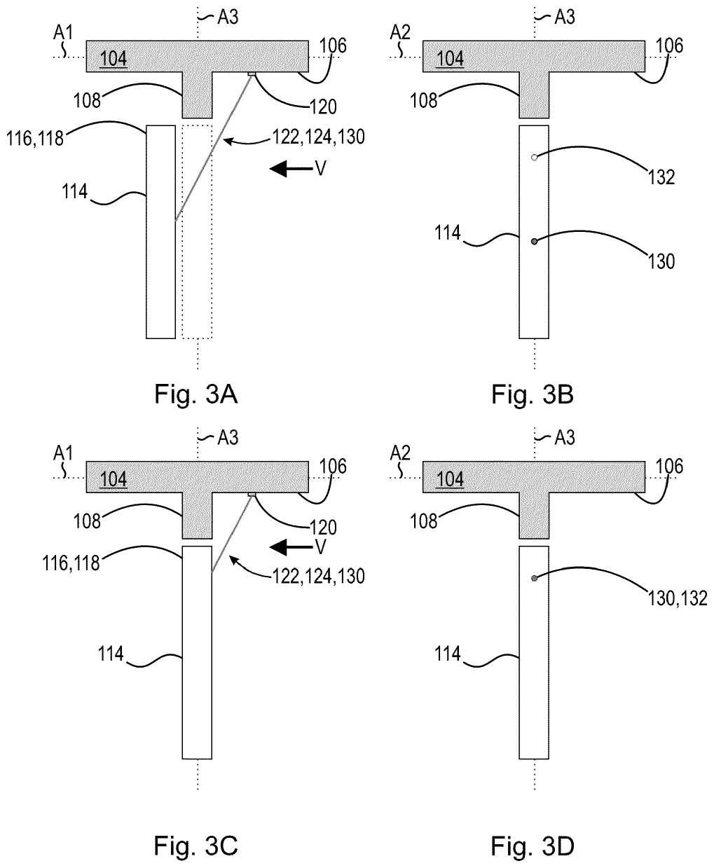

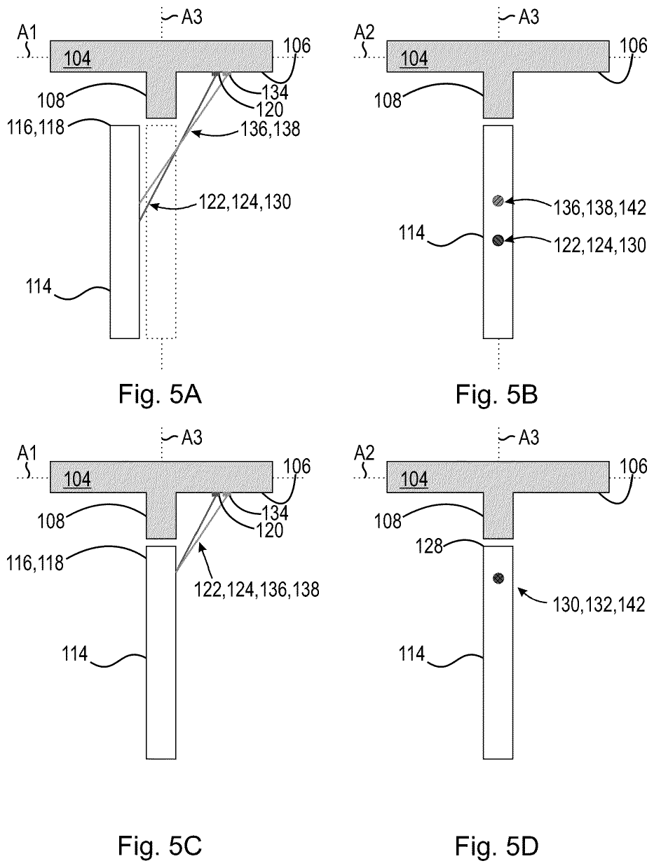

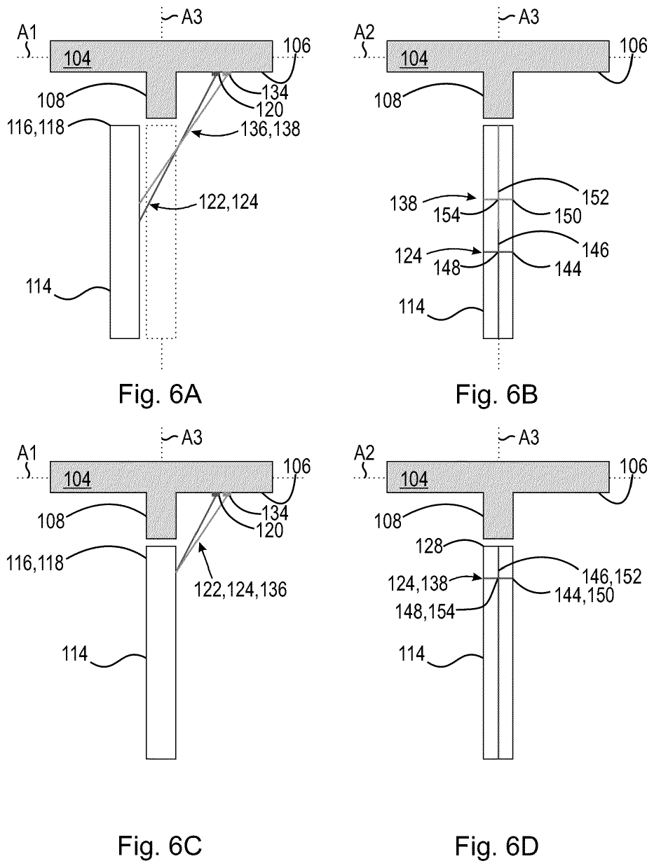

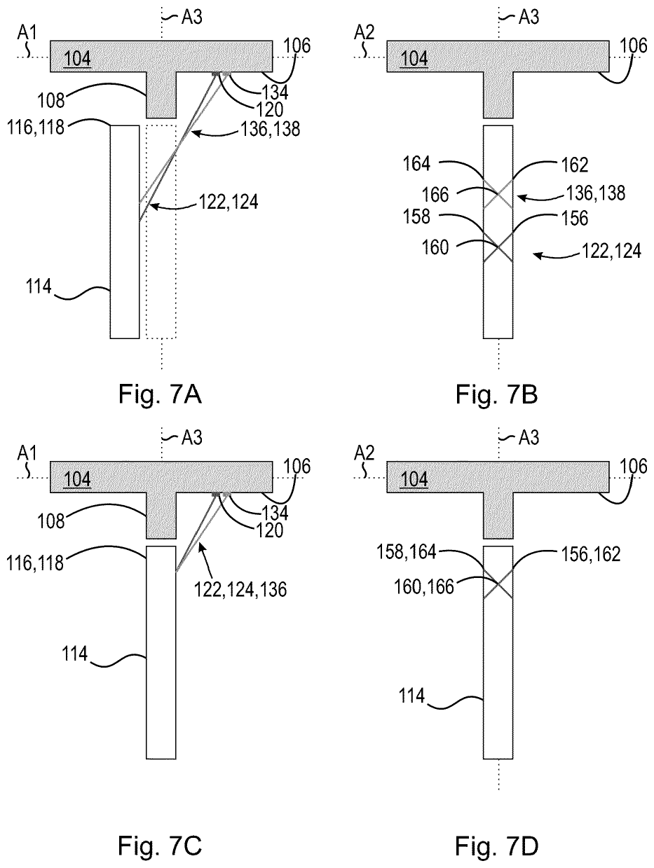

As illustrated in at least FIGS. 2A and 2C, payload 104 may include a first electromagnetic radiation source 120. First electromagnetic radiation source 120 is arranged to produce or generate a first electromagnetic radiation 122. It should be appreciated that first electromagnetic radiation source 120 may be selected from: a single Light-Emitting Diode (LED), a single Organic Light-Emitting Diode (OLED), a plurality of LEDs, a plurality of OLEDs, a laser, or any other electromagnetic radiation source capable of producing a pattern of electromagnetic radiation, e.g., first electromagnetic radiation pattern 124 described below. First electromagnetic radiation source 120 may also be arranged to generate a first electromagnetic radiation pattern 124 using first electromagnetic radiation 122. First electromagnetic radiation pattern 124 can take the form of a dot (shown in FIGS. 3A-3D and 5A-5D), a vertical cross pattern (shown in FIGS. 6A-6B and 9A-10B), a diagonal cross (shown in FIGS. 7A-7D), or any combination thereof.

In one example, illustrated in FIGS. 2A-2D First electromagnetic radiation source 120 may be a point electromagnetic radiation source, e.g., an LED arranged to produce first electromagnetic radiation 122 and first electromagnetic radiation pattern 124. As illustrated, in an example, first electromagnetic radiation pattern 124 may be a cone shaped pattern having at least a top edge, e.g., first top edge 128. In the example shown in FIG. 2A, first electromagnetic radiation 122 is projected at a first angle with respect to third axis A3 such that a portion of first electromagnetic radiation 122 is prevented from contacting first circumferential surface 118 of object 114 by first engagement interface 108 of payload 104 when payload 104 and object 114 are not aligned along at least first axis A1. In other words, first electromagnetic radiation 122 is angled such that first engagement interface 108 casts a shadow on at least a portion of object 114 when payload 104 and object 114 are not aligned along first axis A1. FIG. 2B illustrates the misaligned configuration of FIG. 2A from viewing angle V. To aid in remote alignment, first circumferential surface 118 may have a first alignment window 126. First alignment window 126 can be viewed by a user, e.g., through remote device R, via first image 112 captured by camera 110 at viewing angle V. As can be seen in the misaligned configuration shown in FIG. 2B, when misaligned, first top edge 128 of first electromagnetic radiation pattern 124 and first electromagnetic radiation 122 do not contact or overlap first alignment window 126. During operation of positioning system 100, a user may, via remote device R, drive UAV 102 closer to object 114 along first axis A1 until payload 104 and object 114 are aligned. When object 114 and payload 104 are aligned along first axis A1, as illustrated in FIGS. 2C-2D, first top edge 128 overlaps the top edge of object 114 and first electromagnetic radiation 122 and first electromagnetic radiation pattern 124 cover the entire first alignment window 126. This alignment can be viewed through remote device R, via first image 112 captured by camera 110 at viewing angle V.

In one example, as illustrated in FIGS. 3A-3D, first electromagnetic radiation source 120 may be a laser or other electromagnetic radiation source arrangement capable of generating first electromagnetic radiation pattern 124 in the shape of a dot or small cluster of closely spaced dots forming a single image, i.e., first dot 130. Furthermore, first circumferential surface 118 of object 114 may include a first alignment zone 132 in the shape of a dot or circle. In the example shown in FIG. 3A, first electromagnetic radiation 122 is projected at a first angle with respect to third axis A3 such that it contacts first circumferential surface 118 of object 114 outside of first alignment zone 132 when payload 104 and object 114 are not aligned along first axis A1. FIG. 3B illustrates the misaligned configuration of FIG. 3A from viewing angle V. First alignment zone 132 can be viewed by a user or suitable image recognition modules, e.g., through remote device R, via first image 112 captured by camera 110 at viewing angle V. As can be seen in the misaligned configuration shown in FIG. 3B, when misaligned, first electromagnetic radiation pattern 124 in the form of a dot, i.e., first dot 130, contacts first circumferential surface 118 below first alignment zone 132. During operation of positioning system 100, a user or suitable image recognition modules may, via remote device R, drive UAV 102 closer to object 114 along first axis A1 until payload 104 and object 114 are aligned. When object 114 and payload 104 are aligned along first axis A1, as illustrated in FIGS. 3C-3D, first dot 130 overlaps first alignment zone 132. This alignment can be viewed through remote device R, via first image 112 captured by camera 110 at viewing angle V.

Positioning system 100 may further include a second electromagnetic radiation source, i.e., second electromagnetic radiation source 134. Second electromagnetic radiation source 134 is arranged to produce or generate a second electromagnetic radiation 136. It should be appreciated that second electromagnetic radiation source 134 may be selected from: a single Light-Emitting Diode (LED), a single Organic Light-Emitting Diode (OLED), a plurality of LEDs, a plurality of OLEDs, a laser, or any other electromagnetic radiation source capable of producing a pattern of electromagnetic radiation, e.g., second electromagnetic radiation pattern 138 described below. Second electromagnetic radiation source 134 may also be arranged to generate a second electromagnetic radiation pattern 138 using second electromagnetic radiation 136. Second electromagnetic radiation pattern 138 can take the form of a dot (shown in FIGS. 3A-3D and 5A-5D), a vertical cross pattern (shown in FIGS. 6A-6B and 9A-10B), a diagonal cross (shown in FIGS. 7A-7D), or any combination thereof.

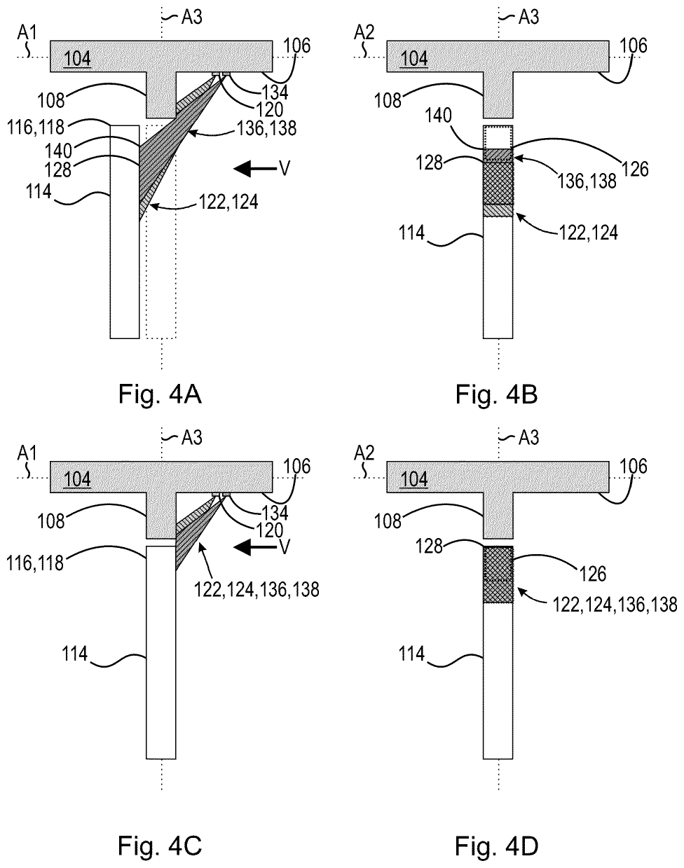

In one example, first electromagnetic radiation source 120 may be a point electromagnetic radiation source, e.g., an LED arranged to produce first electromagnetic radiation 122 and first electromagnetic radiation pattern 124. As illustrated, in an example, first electromagnetic radiation pattern 124 may be a cone shaped pattern having at least a top edge, e.g., first top edge 128. Furthermore, second electromagnetic radiation source 134 may also be a point electromagnetic radiation source, e.g., and LED arranged to produce second electromagnetic radiation 136 and second electromagnetic radiation pattern 138. As illustrated, in this example, second electromagnetic radiation pattern 138 may also be a cone shaped pattern having at least a top edge, e.g., second top edge 140. In the example shown in FIG. 4A, first electromagnetic radiation 122 is projected at a first angle with respect to third axis A3 such that a portion of first electromagnetic radiation 122 is prevented from contacting first circumferential surface 118 of object 114 by first engagement interface 108 of payload 104 when payload 104 and object 114 are not aligned along at least first axis A1. In other words, first electromagnetic radiation 122 is angled such that first engagement interface 108 casts a shadow on at least a portion of object 114 when payload 104 and object 114 are not aligned along first axis A1. Additionally, second electromagnetic radiation 136 is projected at a second angle with respect to third axis A3, e.g., at a greater angle than first electromagnetic radiation 122, such that a portion of second electromagnetic radiation 136 is prevented from contacting first circumferential surface 118 of object 114 by first engagement interface 108 of payload 104 when payload 104 and object 114 are not aligned along at least first axis A1. In other words, second electromagnetic radiation 136 is angled such that first engagement interface 108 casts a shadow on at least a portion of object 114 when payload 104 and object 114 are not aligned along first axis A1. FIG. 4B illustrates the misaligned configuration of FIG. 4A from viewing angle V. To aid in remote alignment, first circumferential surface 118 may have a first alignment window 126. First alignment window 126 can be viewed by a user, e.g., through remote device R, via first image 112 captured by camera 110 at viewing angle V. As can be seen in the misaligned configuration shown in FIG. 4B, when misaligned, first top edge 128 of first electromagnetic radiation pattern 124 and first electromagnetic radiation 122 do not contact or overlap first alignment window 126. Furthermore, when misaligned, although second top edge 140 of second electromagnetic radiation pattern 138 and second electromagnetic radiation 136 may partially overlap first alignment window 126, they do not fully overlap first alignment window 126. During operation of positioning system 100, a user or any suitable image recognition module may, via remote device R, drive UAV 102 closer to object 114 along first axis A1 until payload 104 and object 114 are aligned. When object 114 and payload 104 are aligned along first axis A1, as illustrated in FIGS. 4C-4D, first top edge 128, first electromagnetic radiation 122, second top edge 140 and second electromagnetic radiation 136 cover the entirety of first alignment window 126. This alignment can be viewed through remote device R, via first image 112 captured by camera 110 at viewing angle V.

In one example, as illustrated in FIGS. 5A-5D, first electromagnetic radiation source 120 may be a laser or other electromagnetic radiation source arrangement capable of generating first electromagnetic radiation pattern 124 in the shape of a dot or small cluster of closely spaced dots forming a single image, i.e., first dot 130. Additionally, second electromagnetic radiation source 134 may be a laser or other electromagnetic radiation source arrangement capable of generating second electromagnetic radiation pattern 138 in the shape of a dot or small cluster of closely spaced dots forming a single image, i.e., second dot 142. Furthermore, first circumferential surface 118 of object 114 may include a first alignment zone 132 in the shape of a dot or circle. In the example shown in FIG. 5A, first electromagnetic radiation 122 is projected at a first angle with respect to third axis A3 such that it contacts first circumferential surface 118 of object 114 outside of first alignment zone 132 when payload 104 and object 114 are not aligned along first axis A1. Additionally, second electromagnetic radiation 136 is projected at a second angle with respect to third axis A3, where the second angle is greater than the first angle, such that it also contacts first circumferential surface 118 of object 114 outside of first alignment zone 132 when payload 104 and object 114 are not aligned along first axis A1. FIG. 5B illustrates the misaligned configuration of FIG. 5A from viewing angle V. First alignment zone 132 can be viewed by a user or suitable image recognition module, e.g., through remote device R, via first image 112 captured by camera 110 at viewing angle V. As can be seen in the misaligned configuration shown in FIG. 5B, when misaligned, first electromagnetic radiation pattern 124 in the form of a dot, i.e., first dot 130, and second electromagnetic radiation pattern 138, also in the form of a dot, i.e., second dot 142, contact first circumferential surface 118 below first alignment zone 132. During operation of positioning system 100, a user or any suitable image recognition module may, via remote device R, drive UAV 102 closer to object 114 along first axis A1 until payload 104 and object 114 are aligned. When object 114 and payload 104 are aligned along first axis A1, as illustrated in FIGS. 5C-5D, first dot 130 and second dot 142 overlap first alignment zone 132. This alignment can be viewed through remote device R, via first image 112 captured by camera 110 at viewing angle V.

In one example, as illustrated in FIGS. 6A-6D, first electromagnetic radiation source 120 may be a laser or other electromagnetic radiation source arrangement capable of generating first electromagnetic radiation pattern 124 in the shape of a cross or a “+” shape. First electromagnetic radiation pattern 124 may include a first horizontal component 144 and a first vertical component 146. First horizontal component 144 is arranged to bisect first vertical component 146 at a first intersection point 148. Additionally, second electromagnetic radiation source 134 may be a laser or other electromagnetic radiation source arrangement capable of generating second electromagnetic radiation pattern 138 in the shape of a cross or a “+” shape. Second electromagnetic radiation pattern 138 may include a second horizontal component 150 and a second vertical component 152. Second horizontal component 150 is arranged to bisect second vertical component 152 at a second intersection point 154. In the example shown in FIG. 6A, first electromagnetic radiation 122 is projected at a first angle with respect to third axis A3 and second electromagnetic radiation 136 is projected at a second angle with respect to third axis A3, where the second angle is greater than the first angle, such that the first horizontal component 144 of first electromagnetic radiation pattern 124 and the second horizontal component 150 of second electromagnetic radiation pattern 138 do not overlap when payload 104 and object 114 are not aligned along first axis A1. Additionally, when misaligned, first intersection point 148 and second intersection point 154 do not overlap. FIG. 6B illustrates the misaligned configuration of FIG. 6A from viewing angle V. The misalignment, i.e., the absence of an overlap between the horizontal components or intersection points can be viewed by a user or any suitable image recognition module, e.g., through remote device R, via first image 112 captured by camera 110 at viewing angle V. As can be seen in the misaligned configuration shown in FIG. 6B, when misaligned, first electromagnetic radiation pattern 124 in the form of a “+”, and second electromagnetic radiation pattern 138, also in the form of a “+”, contact first circumferential surface 118 such that they do not overlap. During operation of positioning system 100, a user or image recognition module may, via remote device R, drive UAV 102 closer to object 114 along first axis A1 until payload 104 and object 114 are aligned. When object 114 and payload 104 are aligned along first axis A1, as illustrated in FIGS. 6C-6D, the first horizontal component 144 of first electromagnetic radiation pattern 124 and the second horizontal component 150 of second electromagnetic radiation pattern 138 overlap on first circumferential surface 118. Additionally, first intersection point 148 and second intersection point 154 now overlap as well. This alignment can be viewed through remote device R, via first image 112 captured by camera 110 at viewing angle V.

In one example, as illustrated in FIGS. 7A-7D, first electromagnetic radiation source 120 may be a laser or other electromagnetic radiation source arrangement capable of generating first electromagnetic radiation pattern 124 in the shape of a diagonal cross or an “X” shape. First electromagnetic radiation pattern 124 may include a first diagonal component 156 and a second diagonal component 158. First diagonal component 156 is arranged to bisect second diagonal component 158 at a third intersection point 160. Additionally, second electromagnetic radiation source 134 may be a laser or other electromagnetic radiation source arrangement capable of generating second electromagnetic radiation pattern 138 in the shape of a diagonal cross or an “X” shape. Second electromagnetic radiation pattern 138 may include a third diagonal component 162 and a fourth diagonal component 164. Third diagonal component 162 is arranged to bisect fourth diagonal component 164 at a fourth intersection point 166. In the example shown in FIG. 7A, first electromagnetic radiation 122 is projected at a first angle with respect to third axis A3 and second electromagnetic radiation 136 is projected at a second angle with respect to third axis A3, where the second angle is greater than the first angle, such that the first diagonal component 156 of first electromagnetic radiation pattern 124 and the third diagonal component 162 of second electromagnetic radiation pattern 138 do not overlap, and second diagonal component 158 and fourth diagonal component 164 do not overlap, when payload 104 and object 114 are not aligned along first axis A1. Additionally, when misaligned, third intersection point 160 and fourth intersection point 166 do not overlap. FIG. 7B illustrates the misaligned configuration of FIG. 7A from viewing angle V. The misalignment, i.e., the absence of an overlap between the diagonal components or intersection points discussed above can be viewed by a user, e.g., through remote device R, via first image 112 captured by camera 110 at viewing angle V. As can be seen in the misaligned configuration shown in FIG. 7B, when misaligned, first electromagnetic radiation pattern 124 in the form of a “X”, and second electromagnetic radiation pattern 138, also in the form of a “X”, contact first circumferential surface 118 such that they do not overlap. During operation of positioning system 100, a user may, via remote device R, drive UAV 102 closer to object 114 along first axis A1 until payload 104 and object 114 are aligned. When object 114 and payload 104 are aligned along first axis A1, as illustrated in FIGS. 7C-7D, the first diagonal component 156 of first electromagnetic radiation pattern 124 and the third diagonal component 162 of second electromagnetic radiation pattern 138 overlap, and second diagonal component 158 and fourth diagonal component 164 overlap, on first circumferential surface 118. Additionally, third intersection point 160 and fourth intersection point 166 now overlap as well. This alignment can be viewed through remote device R, via first image 112 captured by camera 110 at viewing angle V.

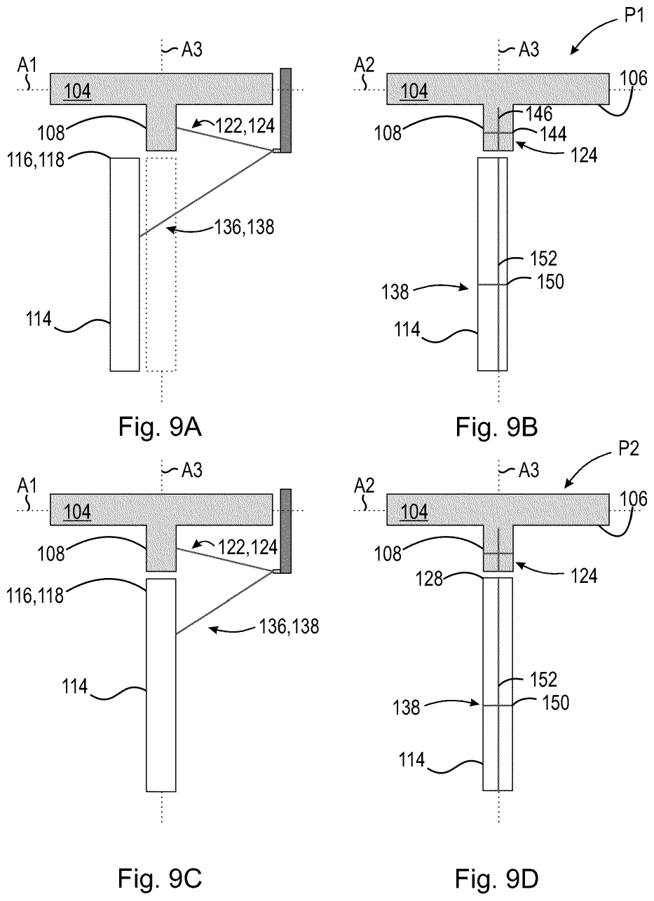

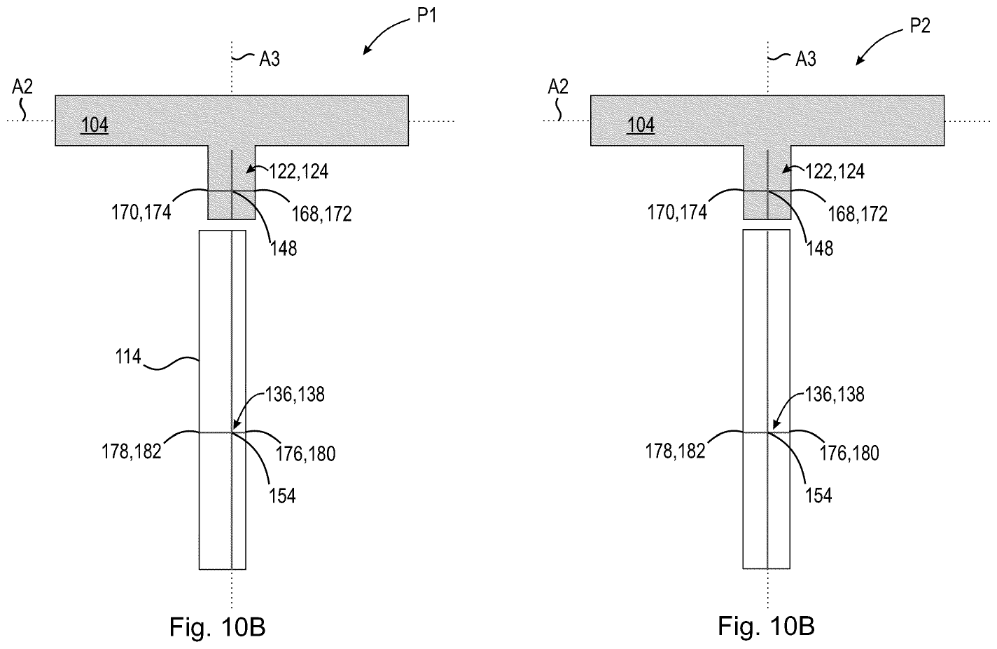

In one example, as illustrated in FIG. 8, first electromagnetic radiation source 120 and second electromagnetic radiation source 134 can be mounted proximate camera 110 such that first electromagnetic radiation 122 having first pattern 124 may be projected onto first engagement interface 108 and second electromagnetic radiation 136 having second electromagnetic radiation pattern 138 may be projected onto first circumferential surface 118 of second engagement interface 116. As will be described below with respect to FIGS. 9A-10B, this configuration allows for additional alignment to be determined along second axis A2 from viewing angle V.

In one example, as illustrated in FIGS. 9A-10B, first horizontal component 144 may further include a first right component 168 and a first left component 170. First right component 168 is arranged along first axis A1 in a first direction DR1 away from first intersection point 148. First left component 170 is arranged along first axis A1 and in a second direction DR2, where second direction DR2 is opposite first direction DR1 and away from first intersection point 148. First right component 168 has first right component length 172 and first left component 170 has first left component length 174, where first right component length 172 and first left component length 174 are the respective measurements of the visible portions of first right component 168 and first left component 170, respectively, that are projected on first engagement interface 108 as viewed from viewing angle V.

Additionally, second horizontal component 150 may further include a second right component 176 and a second left component 178. Second right component 176 is arranged along first axis A1 in a first direction DR1 away from second intersection point 154. Second left component 178 is arranged along first axis A1 and in a second direction DR2, where second direction DR2 is opposite first direction DR1 and away from second intersection point 154. Second right component 176 has second right component length 180 and second left component 178 has second left component length 182, where second right component length 180 and second left component length 182 are the respective measurements of the visible portions of second right component 176 and second left component 178, respectively, that are projected on second engagement interface 116 as viewed from viewing angle V. First right component length 172, first left component length 174, second right component length 180, and second left component length 182 can best be seen in FIGS. 9A-10B.

When payload 104 and object 114 are misaligned, i.e., in first position P1, along second axis A2, illustrated in FIGS. 9A-9B and 10A, the user or some form of image processing module connected to UAV 102 and or remote device R may visually measure first right component length 172, first left component length 174, second right component length 180, and second left component length 182. If the ratio of first right component length 172 of first right component 168 to first left component length 174 of first left component 170 is unequal to the ratio of second right component length 180 of second right component 176 to second left component length 182 of second left component 178, then payload 104 and object 114 are misaligned at least along second axis A2. When object 114 and payload 104 are aligned along second axis A2, i.e., in second position P2 as illustrated in FIGS. 9C-9D and 10B, the ratio of first right component length 172 of first right component 168 to first left component length 174 of first left component 170 is substantially equal to the ratio of second right component length 180 of second right component 176 to second left component length 182 of second left component 178. This principle is embodied in the following two equations:

$$\begin{matrix}Misalignment ( along A 2 ) : \frac{First right component length 172}{First left component length 174} \neq \frac{Second right component length 180}{Second left component length 182} & EQ1 \\ Alignment ( along A 2 ) : \frac{First right component length 172}{First left component length 174} \approx \frac{Second right component length 180}{Second left component length 182} & EQ2\end{matrix}$$

Additionally, camera 110 may be arranged to determine the length of at least a portion of vertical component 152 such that the vertical distance, i.e., the distance between the payload and the object along the third axis may be determined. For example, in the examples illustrated in FIGS. 10A-10B, camera 110 may be arranged to determine the length of vertical component 152 between second intersection point 154 and the top most portion of object 114. The length of this vertical section of vertical component 152 can be used It should be appreciated that, although not illustrated similar measurements can be taken of the diagonal components illustrated and described above with respect to FIGS. 7A-7D such that, in addition to the discussed determination of alignment along the first axis A1, the respective lengths of each diagonal component, and the respective ratios of those lengths on either sides of third intersection point 160 and fourth intersection point 166 may be utilized to determine alignment of payload 104 and object 114 along second axis A2.

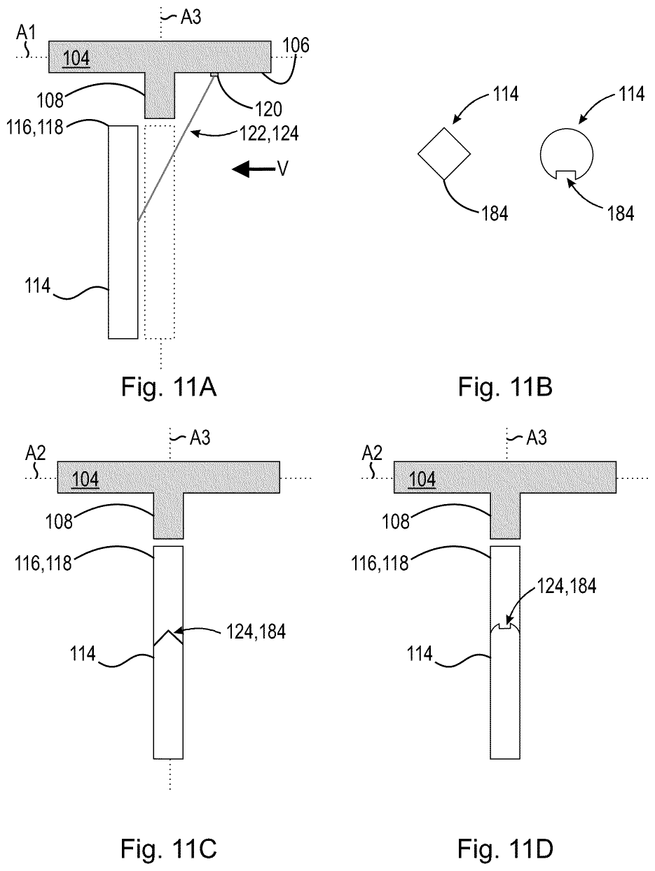

In an example, illustrated in FIGS. 11A-11D, first electromagnetic radiation source 120 may be a laser or other electromagnetic radiation source arrangement capable of generating first electromagnetic radiation pattern 124 in the shape of a horizontal line, i.e., a line arranged substantially along second axis A2. Furthermore, first circumferential surface 118 of object 114 may include a first object feature 184. In an example, first object feature 184 may be a projection, recess, channel, aperture, or other physical artifact that would distort the image of first electromagnetic radiation pattern 124, i.e., from being a substantially horizontal line, such that it may easily be viewed from viewing angle V. In another example, first object feature could be physical orientation of object 114, e.g., an edge of a square shaped object. Two examples of these features are illustrated in FIG. 11B, i.e., a square cross-sectional pattern of object 114 and a substantially circular cross-section of object 114 having a channel or notch removed creating a distinct visual artifact. In the examples shown in FIG. 11C, first electromagnetic radiation 122 is projected at a first angle with respect to third axis A3 such that it contacts first circumferential surface 118 of object 114. When aligned along second axis A2, first object feature 184 will be centered about the surface of object 114 as illustrated in FIGS. 11C-11D. Although not illustrated, similarly to the examples discussed above, an alignment window or acceptable vertical positioning of the object feature and horizontal line created by electromagnetic radiation pattern 124 may also be used to determine alignment along first axis A1. Additionally, when approaching an object 114, e.g., a street lamp, it should be appreciated that the perceived position of the first object feature 184 may indicate the rotational position of the object with respect to payload 104 about axis A3 such that camera 110 or user remotely controlling UAV 102 can determine a starting position prior to aligning payload 104 with object 114, for example, along first axis A1 or second axis A2.

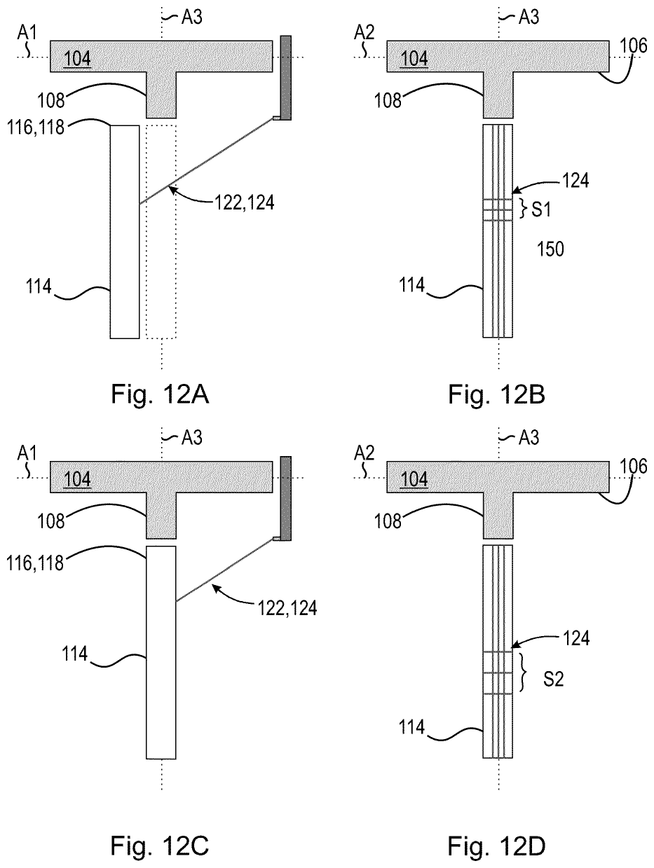

In an example, illustrated in FIGS. 12A-12D, first electromagnetic radiation source 120 may be a laser or other electromagnetic radiation source arrangement capable of generating first electromagnetic radiation pattern 124 in the shape of a plurality of vertical lines arranged along third axis A3 and a plurality of horizontal lines arranged substantially along, e.g., second axis A2, i.e., a grid pattern. As illustrated in FIGS. 12A-12B, i.e., when payload 104 and object 114 are not aligned along at least second axis A2, first electromagnetic radiation pattern 124 has a first scale S1 where the vertical spacing and horizontal spacing between the lines of the grid measure a first distance relative to each other. When aligned, as illustrated in FIGS. 12C-12D, as payload 104 moves closer to object 114 along first axis A1, since first pattern 124 is generated by a small or point electromagnetic radiation source, the scale of pattern 124 as seen from viewing angle V increases to a second scale S2, where second scale S2 is larger than the first scale S1. In other words, the vertical and horizontal spacing between the vertical and horizontal lines of first electromagnetic radiation pattern 124 increase. This change in scale from S1 to S2 can be viewed by a user and/or a visual processing module arranged to process first image 112 from camera 110.

During operation of any of the foregoing example configurations, when UAV 102 makes an initial approach in the direction of object 114, UAV 102 and first electromagnetic radiation source 120 and second electromagnetic radiation source 134 may be at too great a distance for any of the foregoing electromagnetic radiation patterns to project onto object 114 with sufficient clarity. In the event of this long-distance approach, additional long-distance guidance may be necessary. Therefore, although not illustrated, it should be appreciated that first electromagnetic radiation source 120 or second electromagnetic radiation source 134 may initially project an array of unique identification symbols along a plurality of angles with respect to third axis A3. In other words, first electromagnetic radiation source 120 and second electromagnetic radiation source 134 may project a unique symbol at every 5 degrees about third axis A3 such that at least one unique symbol of the array of unique identification symbols contacts outer circumferential surface 118 of second engagement interface 116. In one example, these unique identification symbols may be selected from: Quick Response (QR) codes, direction arrows (e.g., an upward facing arrow, a downward facing arrow, a left facing arrow, etc.), positing and negative distance measurements (e.g., −10 m, +10 m, etc.), or any other unique set of symbols that would help visually aid the rough and/or long-distance positioning and alignment of UAV 102 with object 114. Once the long distance guidance is complete, i.e., the UAV 102 and/or payload 104 are within a predetermined distance, e.g., +/−1 m, any of the foregoing alignment configurations, or any combination of any of the foregoing alignment configurations may be used for fine positioning and alignment along first axis A1 and/or second axis A2. Once in position for fine alignment adjustments, i.e., in a first position P1, any of the foregoing configurations may be utilized to guide payload 104 along first axis A1 and/or second axis A2 so that it is aligned along first axis A1 and/or second axis A2, i.e., second position P2.

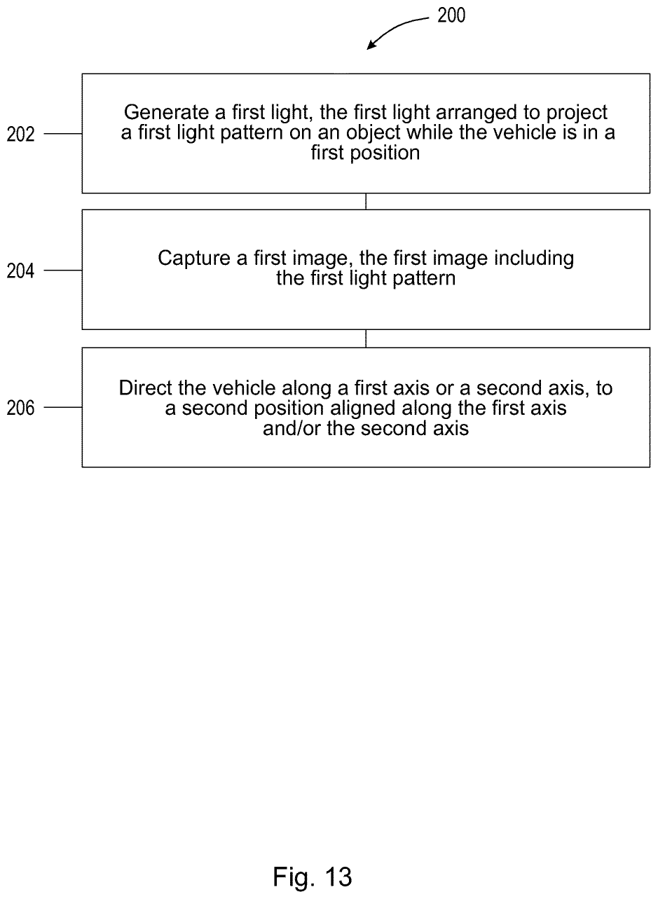

FIG. 13 illustrates a flow chart of method 200 according to the present disclosure. Method 200 may include, for example: generating, via a first electromagnetic radiation source 120 connected to vehicle 101, for example, an unmanned aerial vehicle (UAV) 102 or the payload 104, a first electromagnetic radiation 122, the first electromagnetic radiation 122 arranged to project a first electromagnetic radiation pattern 124 on an object 114 while the UAV 102 is in a first position with respect to the object 114 (step 202); capturing, via a camera 110 connected to the UAV 102, a first image 112, the first image 112 including the first electromagnetic radiation pattern 124 projected on the object 114 while the UAV 102 is in the first position (step 204); directing the UAV 102 to move along a first axis A1 or a second axis A2, where the second axis is orthogonal to the first axis, to a second position based at least in part on the first image 112, wherein the second position is aligned with the object along the first axis and/or the second axis (step 206).

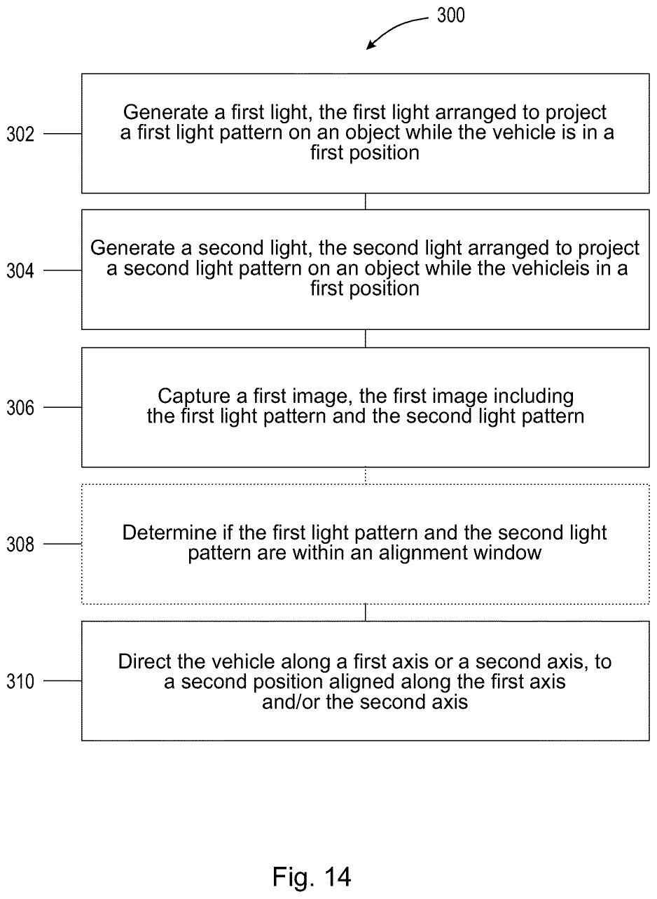

FIG. 14 illustrates a flow chart of method 300 according to the present disclosure. Method 300 may include, for example: generating, via a first electromagnetic radiation source 120 connected to vehicle 101, for example, an unmanned aerial vehicle (UAV) 102 or the payload 104, a first electromagnetic radiation 122, the first electromagnetic radiation 122 arranged to project a first electromagnetic radiation pattern 124 on an object 114 while the UAV 102 is in a first position with respect to the object 114 (step 302); generating, via a second electromagnetic radiation source 134 connected to the UAV 102 or the payload 104, a second electromagnetic radiation 136, the second electromagnetic radiation 136 arranged to project a second electromagnetic radiation pattern 138 on the object 114, wherein the first electromagnetic radiation pattern 124 is arranged to overlap the second electromagnetic radiation pattern 138 when the payload 104 and the object 114 are aligned along the second axis A1 and/or the second axis A2 (step 304); capturing, via a camera 110 connected to the UAV 102, a first image 112, the first image 112 including the first electromagnetic radiation pattern 124 and the second electromagnetic radiation pattern 138 projected on the object 114 while the UAV 102 is in the first position (step 306); directing the UAV 102 to move along a first axis or a second axis, where the second axis is orthogonal to the first axis, to a second position based at least in part on the first image 112, wherein the second position is aligned with the object 114 along the first axis and/or the second axis (step 310). Optionally, between step 306 and 310, method 300 may further include: generating, via a second electromagnetic radiation source 136 connected to the UAV 102 or the payload 104, a second electromagnetic radiation 136, the second electromagnetic radiation 136 arranged to project a second electromagnetic radiation pattern 138 on the object 114 while the UAV 102 is in the first position with respect to the object 114, wherein the first electromagnetic radiation pattern 124 and the second electromagnetic radiation pattern 138 are arranged to project onto an alignment window 126 of the object 114 when the payload 104 is aligned with the object 114 along the first axis and/or the second axis (step 308).

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A system for positioning a payload above an object, the system comprising:
a vehicle;
the payload, the payload having a first surface, the first surface having a first engagement interface;
the object, the object having a second engagement interface arranged to engage with the first engagement interface when the first engagement interface is aligned with the second engagement interface;
a first electromagnetic radiation source arranged to generate a first electromagnetic radiation, the first electromagnetic radiation source positioned on the payload, such that the first electromagnetic radiation is arranged to create a first electromagnetic radiation pattern on the object when the payload and the object are aligned, wherein first electromagnetic radiation pattern is arranged to project onto an alignment window of the object when the payload is aligned with the object.

2. The system of claim 1, wherein the vehicle further comprises a camera arranged to capture a first image of the first electromagnetic radiation pattern on the object, the camera operatively engaged with the first electromagnetic radiation source.

3. (canceled)

4. The system of claim 1, further comprising a second electromagnetic radiation source arranged to generate a second electromagnetic radiation, the second electromagnetic radiation source positioned on the payload or connected to the vehicle, such that the second electromagnetic radiation is arranged to create a second electromagnetic radiation pattern on the object or on the first engagement interface of the vehicle.

5. The system of claim 4, wherein the first electromagnetic radiation pattern comprises a first horizontal component arranged substantially parallel to a first axis and a first vertical component arranged substantially parallel a second axis orthogonal to the first axis, wherein the first vertical component is arranged to bisect the first horizontal component at a first intersection point.

6. The system of claim 5, wherein the first horizontal component comprises:
a first right component arranged in a first direction along the first axis with respect to the first intersection point, the first right component having a first right component length; and,
a first left component arranged in a second direction along the first axis with respect to the first intersection point, where the second direction is opposite the first direction, the first left component having a first left component length;
wherein, the payload and object are aligned along the first axis when the first right component length and the first left component length are substantially equal.

7. The system of claim 5, wherein the second electromagnetic radiation pattern includes a second horizontal component and a second vertical component wherein the second vertical component is arranged to bisect the second horizontal component at a second intersection point and wherein the payload and the object are aligned along the second axis when the first intersection point and the second intersection point overlap.

8. The system of claim 7, wherein the second electromagnetic radiation pattern further comprises:
a second left component arranged in the first direction along the first axis with respect to the second intersection point, the second left component having a second left component length; and,
a second right component arranged in the second direction along the first axis with respect to the second intersection point, the second right component having a second right component length,
wherein the payload and the object are aligned along the first axis when the ratio of the first left component to the first right component is substantially equal to the ratio of the second left component and the second right component.

9. The system of claim 4, wherein the first electromagnetic radiation pattern comprises a first diagonal component and a second diagonal component, wherein the first diagonal component is arranged to bisect the second diagonal component at a third intersection point.

10. The system of claim 9, wherein the second electromagnetic radiation pattern comprises a third diagonal component and a fourth diagonal component, wherein the third diagonal component is arranged to bisect the fourth diagonal component at a fourth intersection point and wherein the payload and the object are aligned along a second axis when the third intersection point and the fourth intersection point overlap.

11. The system of claim 4 wherein the first electromagnetic radiation pattern is a first dot and the second electromagnetic radiation pattern is a second dot and the payload and the object are aligned along the second axis when the first dot overlaps the second dot.

12. The system of claim 4, wherein the first electromagnetic radiation pattern comprises a first top edge created by a portion of first electromagnetic radiation contacting the first engagement interface and the second electromagnetic radiation pattern comprises a second top edge created by the second electromagnetic radiation contacting the first engagement interface wherein the payload and the object are aligned along the second axis when the first top edge overlaps the second top edge.

13. A method of aligning a payload and an object, the method comprising:
generating, via a first electromagnetic radiation source connected to the payload, a first electromagnetic radiation, the first electromagnetic radiation arranged to project a first electromagnetic radiation pattern on an object while the vehicle is in a first position with respect to the object, wherein the first electromagnetic radiation pattern is arranged to project onto an alignment window of the object when the payload is aligned with the object;
capturing, via a camera connected to a vehicle, a first image, the first image including the first electromagnetic radiation pattern projected on the object while the vehicle is in the first position;
directing the vehicle to move along a first axis or a second axis, where the second axis is orthogonal to the first axis, to a second position based at least in part on the first image, wherein the second position is aligned with the object along the first axis and/or the second axis.

14. The method of claim 13, further comprising:
generating, via a second electromagnetic radiation source connected to the vehicle or the payload, a second electromagnetic radiation, the second electromagnetic radiation arranged to project a second electromagnetic radiation pattern on the object while the vehicle is in the first position with respect to the object, wherein the first electromagnetic radiation pattern and the second electromagnetic radiation pattern are arranged to project onto the alignment window of the object when the payload is aligned with the object along the first axis and/or the second axis.

15. The method of claim 13 further comprising:
generating, via a second electromagnetic radiation source connected to the vehicle or the payload, a second electromagnetic radiation, the second electromagnetic radiation arranged to project a second electromagnetic radiation pattern on the object, wherein the first electromagnetic radiation pattern is arranged to overlap the second electromagnetic radiation pattern when the payload and the object are aligned along the first axis and/or the second axis.
